(19) United States
(12) Patent Application Publication
(10) Pub. No.: US 2006/0022761 A1
(43) Pub. Date: Feb. 2, 2006

(54) Chip-scale atomic clock (CSAC) and method for making same

(76) Inventors: Joseph H. Abeles, East Brunswick, NJ (US); Alan M. Braun, Lawrenceville, NJ (US); Winston Kong Chan, Princeton, NJ (US); Martin H. Kwakernaak, New Brunswick, NJ (US); Steven A. Lipp, West Windsor, NJ (US); Alfred Joseph Ulmer, Beverly, NJ (US)

Correspondence Address: PLEVY, HOWARD, & DARCY, PC, P. O. BOX 226, FORT WASHINGTON, PA, 19034, US

(21) Appl. No.: 11/183,561

(22) Filed: Jul. 18, 2005

Related U.S. Application Data
(63) Continuation-in-part of application No. 11/030,009, filed on Jan. 5, 2005.
(60) Provisional application No. 60/588,493, filed on Jul. 16, 2004.
(60) Provisional application No. 60/618,918, filed on Oct. 14, 2004.

(51) Int. Cl. H01S 1/06

(52) U.S. Cl. 331/94.1

(57) ABSTRACT

A clock including: a portable, at least partially evacuated housing; a cell being positioned within the housing and including an internal cavity having interior dimensions each less than about 1 millimeter, an intra-cavity pressure of at least about 760 Torr, and containing a metal atomic vapor; an electrical to optical energy converter being positioned within the housing to emit light through the metal atomic vapor; an optical energy intensity detector being positioned within the housing to receive the light emitted by the converter through the metal atomic vapor; at least one conductive winding around the cavity to stabilize the magnetic field experienced in the cavity dependently upon the detector; and, an output to provide a signal from the housing dependently upon the detector detecting the light emitted by the converter through the metal atomic vapor.

### RELATED APPLICATION

This application is a continuation-in-part application of U.S. patent application Ser. No. 11/030,009, filed Jan. 30, 2005, entitled ANODICALLY BONDED CELL, METHOD FOR MAKING SAME, AND SYSTEMS INCORPORATING SAME (SAR-14968), and claims priority of: U.S. Patent Application Ser. No. 60/588,493, filed Jul. 16, 2004, entitled METHOD AND APPARATUS FOR PROVIDING A MICRO-ATOMIC CLOCK (SAR-15131-P); U.S. Patent Application Ser. No. 60/618,918, filed Oct. 14, 2004, entitled MAGNETIC FIELD STABILIZATION BY PHASE SENSITIVE DETECTION OF ATOMIC ZEEMAN RESONANCE IN AN ATOMIC VAPOR (SAR-15173-PA), the entire disclosures of which are each hereby incorporated by reference as if being set forth in their respective entireties herein.

### GOVERNMENT RIGHTS

The invention was made with U.S. government support, and the U.S. Government has certain rights in the invention, as provided for by the terms of contract number NBCHC020045 (DARPA).

### FIELD OF THE INVENTION

The present invention relates generally to atomic clocks and systems incorporating atomic clocks, and more particularly to Chip-Scale Atomic Clocks (CSACs) and systems incorporating CSACs.

### BACKGROUND OF THE INVENTION

An atomic clock is a precise timekeeping device regulated by a characteristic invariant frequency of an atomic system. A second may be defined as 9,192,631,770 cycles of the radiation that corresponds to the transition between two energy levels of the ground state of the Cesium-133 atom. Atomic clocks typically use an alkali metal atomic vapor (hereinafter “atomic vapor”), such as a Cesium (Cs) atom containing vapor. A Rubidium (Rb) containing vapor may also be used, for example. The energy level transition typically utilized is the 0-0 transition.

It is believed to be desirable to provide compact atomic clocks, such as Chip-Scale Atomic Clocks (CSACs). However, conventional approaches have failed to realize CSACs, at least in part, due to a fundamental inability to miniaturize atomic vapor containing cells while maintaining desirable 0-0 transition based signal strengths.

### SUMMARY OF THE INVENTION

A clock including: a portable, at least partially evacuated housing; a cell being positioned within the housing and including an internal cavity having interior dimensions each less than about 1 millimeter, an intra-cavity pressure of at least about 760 Torr, and containing a metal atomic vapor; an electrical to optical energy converter being positioned within the housing to emit light through the metal atomic vapor; an optical energy intensity detector being positioned within the housing to receive the light emitted by the converter through the metal atomic vapor; at least one conductive winding around the cavity to stabilize the magnetic field experienced in the cavity dependently upon the detector; and, an output to provide a signal from the housing dependently upon the detector detecting the light emitted by the converter through the metal atomic vapor.

### BRIEF DESCRIPTION OF THE FIGURES

Understanding of the present invention will be facilitated by consideration of the following detailed description of the preferred embodiments of the present invention taken in conjunction with the accompanying drawings, wherein like numerals refer to like parts and:

FIG. 1 illustrates a cell according to an aspect of the present invention;

FIG. 2 illustrates a process for making a cell according to an aspect of the present invention;

FIG. 3 illustrates an array of cells according to an aspect of the present invention;

FIG. 4 illustrates a process for filling a cell according to an aspect of the present invention;

FIGS. 5A-5D illustrate various views of an apparatus useful in fabricating a cell according to an aspect of the present invention.

FIG. 6 illustrates a device incorporating the cell of FIG. 1, according to an aspect of the present invention;

FIGS. 7 and 8 illustrate views of a laser structure according to an aspect of the present invention;

FIGS. 9 and 10 illustrate a system according to an aspect of the present invention;

FIGS. 11 and 12 illustrate different approaches according to aspects of the present invention;

FIG. 13 illustrates a clock system according to an aspect of the present invention;

FIG. 14 illustrates cell transmission and a corresponding error signal that may be used according to an aspect of the present invention;

FIG. 15 illustrates amplitude and phase of modulation as a result of magnetic field modulation according to an aspect of the present invention;

FIG. 16 illustrates in-phase (bottom) and out-of-phase (top) modulation components with applied magnetic field modulation according to an aspect of the present invention;

FIG. 17 illustrates a laser noise spectrum according to an aspect of the present invention; and,

FIGS. 18-21 illustrate design consideration simulation data according to an aspect of the present invention.

### DETAILED DESCRIPTION OF THE PREFERRED EMBODIMENTS OF THE INVENTION

It is to be understood that the figures and descriptions of the present invention have been simplified to illustrate elements that are relevant for a clear understanding of the present invention, while eliminating, for purposes of clarity, many other elements found in typical atomic clocks, atomic clock cells, systems incorporating clocks, oscillators, and manufacture methods relating thereto. Those of ordinary skill in the art will recognize that other elements are desirable and/or required in order to implement the present invention. However, because such elements are well known in the art, and because they do not facilitate a better understanding of the present invention, a discussion of such elements is not provided herein. The disclosure herein is directed to all such variations and modifications to such elements and methods known to those skilled in the art.

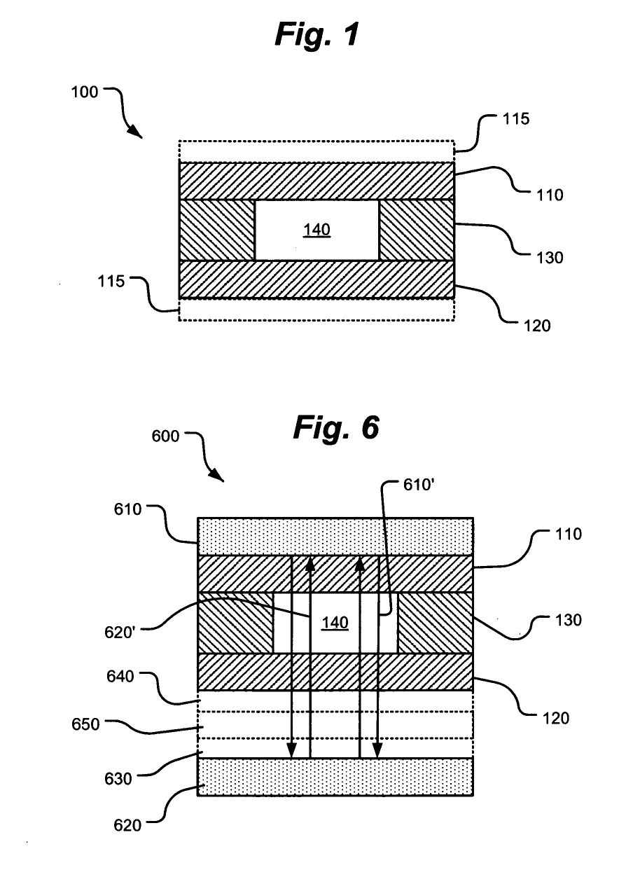

Referring now to FIG. 1, there is shown a cavity structure, or cell, 100 according to an aspect of the present invention. Structure 100 generally includes layers 110, 120 and 130 forming closed cavity 140. By way of non-limiting example, layers 110, 120 may take the form of an amorphous silicate having an ion mobility and temperature expansion coefficient approximately that of silicon, such as a borosilicate glass like Pyrex, which is commercially available from DuPont, where layer 130 takes the form of single crystal silicon wafer. Cavity 140 may contain an alkali metal atomic vapor, such as metallic cesium or other alkali metal, and a ratioed mixture of buffer gas species to provide for temperature-fluctuation invariant pressure shifts, such as Ar:N₂ with ratio 28%:72%, for example. The present invention will be discussed as it relates to Cs, however another alkali metals, such as Rb, may be used.

By way of non-limiting example, cavity 140 may have an inner, lateral dimension on the order of about 100 micrometers (μm) to about 3 millimeters (mm). Smaller or larger cells may also be used though. By way of non-limiting example, cavity 140 may have internal dimensions on the order of about 0.25 mm×0.4 mm×0.4 mm. Cavity 140 may have an internal volume on the order of about a nanoliter (nl) to about a microliter (μl), although, again, cells of other sizes may be used. The relatively small size of structure 100 may serve to reduce power consumption as compared to larger devices, as reduced cell surface area reduces radiated power loss, minimizing power needed to maintain cell 100 at operating temperature, such as about 120 degrees Celsius (C). In addition, convective heat loss is mitigated by packaging cell within vacuum enclosure, conductive losses are minimized by utilizing thermally-isolating cell support system. Cavity 140 may contain a low pressure environment (having a pressure below about an atmosphere, or 760 Torr) or a high pressure cell (having an internal pressure up to about 10 atmospheres), for example. As the interior dimensions of the cell decrease, internal buffer gas pressure can be increased to maintain constant alkali interaction with the cell wall (buffer gas impedes alkali diffusion into cell walls). Increase in buffer gas pressure goes as the square of reduction in cell dimension. As cell size is reduced, cell operating temperature is increased to maintain constant optical absorption depth. Increased cell temperature causes increased alkali-cell vapor density, such that alkali-alkali ‘spin-exchange’ collisional broadening begins to dominate the signal fidelity. This effect conventionally limits atomic clock cell dimensions to greater than mm. According to an aspect of the present invention, alkali end-state may be used in combination with smaller cell dimensions, with suppressed spin-exchange effects.

Cell 100 may optionally include heater(s) 115. Each heater 115 may take the form of a patterned indium tin oxide structure, by way of non-limiting example only. Each heater 115 may have an operating range of about 110±30 C, for example. Heater(s) 115 may be selectively activated, using attached leads (not shown) for example. By selectively activating heaters 115, the temperature of cavity 140, and hence the Cs within cavity 140, may be elevated to the cell operating temperature.

According to an aspect of the present invention, each ITO heater 115 may be lithographically patterned to provide for different heating effects in different regions of cavity 140. By selectively heating different portions of cavity 140 differently, liquid cesium in cavity 140 may be accumulated near one side or a periphery, where it is less likely to undesirably obstruct transmissions through the cavity.

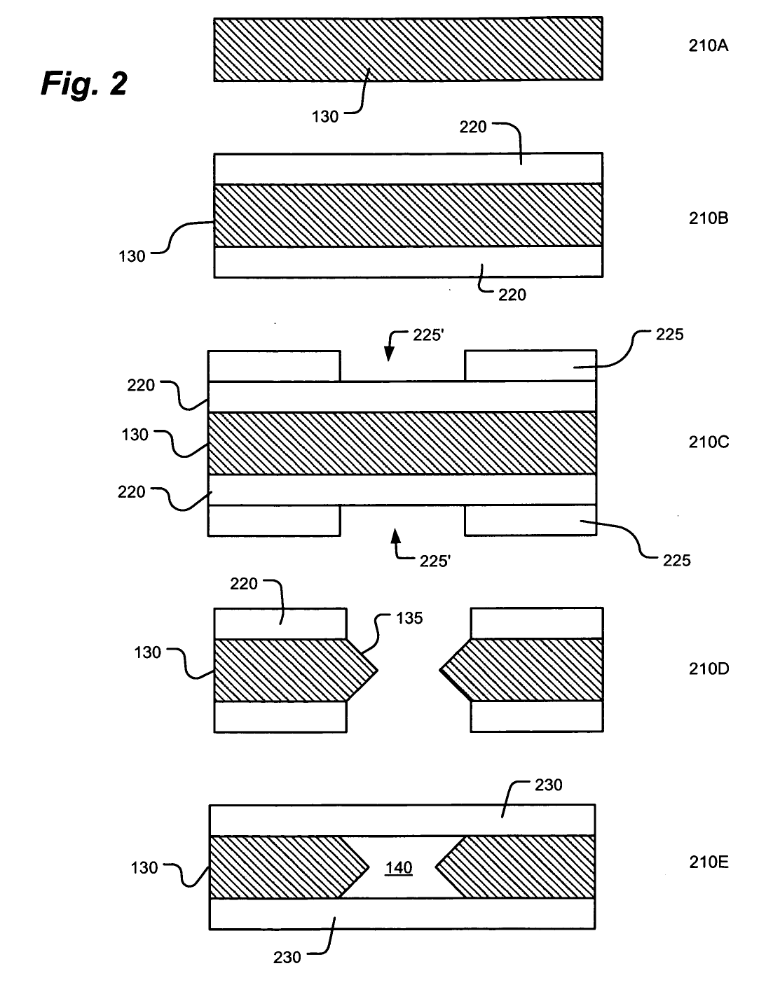

Referring now also to FIG. 2, there are shown structures 210A-210E. Structures 210A-210E represent a single structure at various processing stages. Referring first to structure 210A, there is shown a wafer 130. Wafer 130 may take the form of a polished single crystal silicon wafer. By way of non-limiting example only, the wafer may be about ½ to about 2 mm thick, depending upon the desired depth of cavity 140 (FIG. 1), for example. Referring now also to structure 210B, layers 220 may be provided on wafer 130. Each layer 220 may be composed of SiₓN_{y}, such as Si₃N₄, or an oxide for example. Each layer 220 may be up to about 10,000 angstroms thick, for example. Layers 220 may be plasma enhanced chemical vapor deposited (PECVDed) upon wafer 130, for example. Layers 220 may serve as etch masks for wafer 130.

Referring now also to structure 210C, layers 225 may be provided over layers 220. Layers 225 may take the form of dry film photoresist, such as Riston, which is commercially available from DuPont. Layers 225 may be patterned using conventional photolithographic processing to provide opening(s) 225′. The size of each opening 225′ may determine the eventual length and width of cavity 140 (FIG. 1). The shape of opening 225′ may determine the eventual shape of cavity 140 (FIG. 1). The remaining portion(s) of layers 230 may then be used as an etch mask for layers 220. Conventional CF₄ plasma etching may be used to remove the unmasked portions of layers 220, for example.

Referring now also to structure 210D, the remaining portions of layers 220 may serve as an anisotropic etch mask for wafer 130. A caustic etch, such as one using a mixture of KOH, water and n-propanol may be used. As will be understood by those possessing an ordinary skill in the pertinent arts, such an etch is crystallographic plane selective such that the sidewalls 135 of cavity 140 are oriented at 57° to the surface plane. As will also be recognized by one possessing an ordinary skill in the pertinent arts, this may lead to a certain relation of cavity opening size at the surface of silicon wafer 130 to overall device width and length. Other techniques and materials may optionally be used in lieu of, or in addition to, the caustic etch to provide for smaller overall devices for a given cavity opening by etching more vertical sidewalls. For example, a deep reactive ion etch (RIE), physical machining or eroding or plasma etch of silicon wafer 130 may provide for more vertical sidewalls, that in turn provide a smaller overall device size for a given cavity opening. Overall device size may approach 125% of cavity opening size, for example. Regardless, the remaining portions of layers 220 may be removed by wet chemical etching, such as by using a buffered HF or phosphoric acid.

Referring now also to structure 210E, wafer 130 may then be anodically bonded to top and bottom plates 630. According to an aspect of the present invention, plates 630 may each be transparent to electromagnetic energy used to pump the alkali metal atomic vapor in cavity 140 (FIG. 1), e.g., around 894 nm, or other known alkali optical pump lines, e.g., 780 nm, 795 nm or 850 nm, for example. Plates 230 may each take the form of an amorphous silicate having an ion mobility and temperature expansion coefficient approximately that of wafer 130, e.g., single crystal silicon. For example, each of the top and bottom plates 230 may take the form of a Pyrex 7740 glass sheet having a thickness between about 0.5 and 1 mm, such as about 0.6 mm, for example. Herein, Pyrex glass plates 230 serve as layers 110, 120 (FIG. 1).

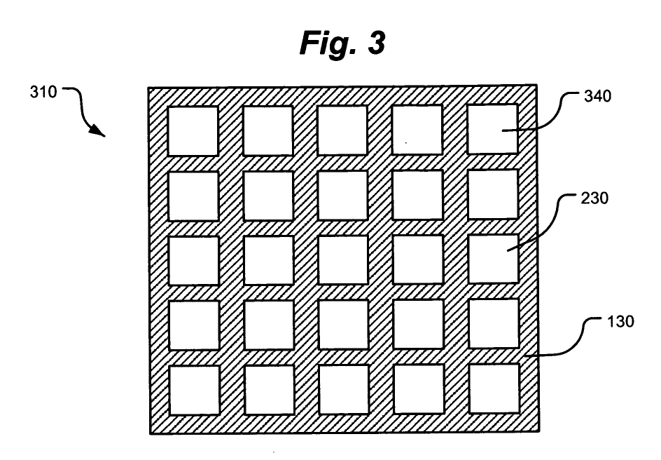

Referring now to FIG. 3, there is shown a plan view of an array 310 of cavities 340 each corresponding to a cavity 140 (FIG. 1) after a first plate 230 has been anodically bonded to a patterned wafer 130. As may be seen therein, vias patterned through wafer 130 to plate 230 define an array of batch processed, yet open-topped cavities 140 suitable for filling and sealing. After batch cavity formation, filling and sealing, array 310 may be divided to provide individual cells 100 using conventional separating techniques, such as dicing or cleaving.

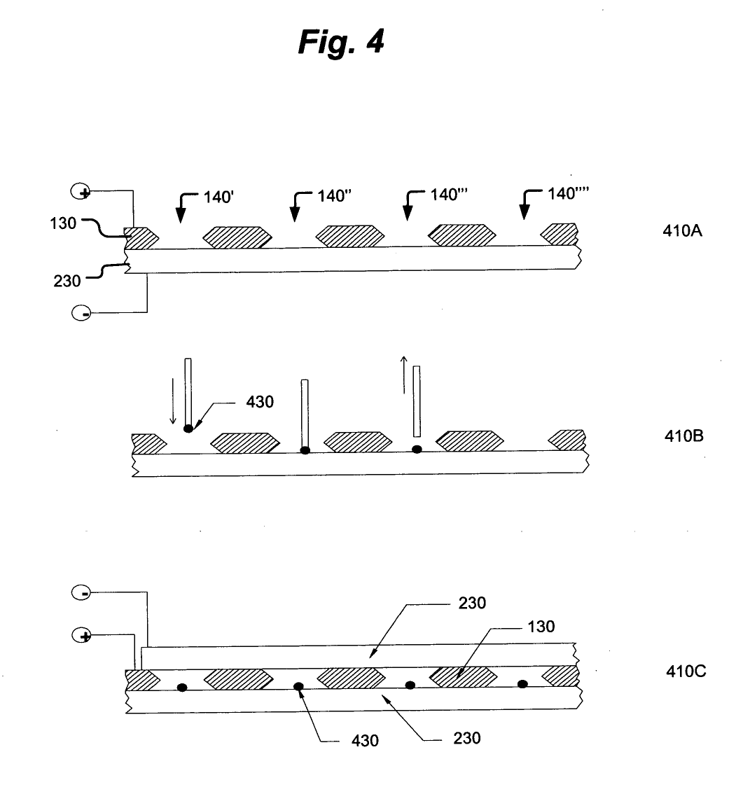

Referring now also to FIG. 4, there are shown structures 410A-410C. Structures 410A-410C illustrate a partial cross-sectional view of an array analogous to array 310 of FIG. 3, at various processing stages. Referring first to structure 410A, there is shown patterned silicon wafer 130 bonded to a single plate 230. Wafer 130 may be positively charged with respect to plate 230 to facilitate anodic bonding. Application of around 1 kilovolt (kV) at around 300 C or greater may be used to anodically bond the illustrated wafer 130 and plate 230. Thus, wafer 130 may be batch processed to yield a plurality of cavity openings 140′-140″″. For example, silicon wafer 130 may be patterned by chemical etching, and anodically bonded to a 0.6 mm thick Pyrex 7740 plate at a temperature of greater than about 300 C. Structure 410A may be placed in an inert, buffer gas environment suitable for use within the cavities, such as a gas composition of about 72.5% nitrogen and 27.5% argon.

Referring now also to structure 410B, a liquid alkali metal pin transfer to each cell cavity 140′-140″″ at a temperature greater than the melting point of the alkali metal (Cs is about 30 C) and within the buffer gas environment may be effected. For example, a liquid Cs metal pin transfer at a temperature around 100 C within a buffer gas environment, e.g., a buffer gas containing enclosure or glove box, may be effected. This may serve to facilitate more rapid anodic bonding of the sealing plates after Cs insertion by, in effect, pre-heating the silicon wafer 130. A fine tungsten-carbide drill bit may prove well suited to effect manual pin transfer, where the flutes y facilitate liquid Cs transfer. Optionally, an array of pins may be used to substantially simultaneously deliver the alkali metal to a plurality of cavities, e.g., 140′, 140″, 140′″ and 140″″.

According to an aspect of the present invention, each cell cavity may be coated with a protectant, such as SiO₂, Al₂O₃ or SiₓN_{y} prior to Cs pin transfer or the second plate 230 being bonded to the silicon wafer 130. This may be accomplished using conventional plasma enhanced chemical vapor deposition, for example. The protectant may serve to provide an about 1000 angstroms thick protectant layer over at least a part of the exposed portions of the interior of cavity 140 and an exposed surface of wafer 130. The coated, top surface of wafer 130 may be polished to remove corresponding portion(s) of the protectant. The protectant remaining within the cell cavity 140 may serve to prevent wicking of the liquid Cs up the sidewalls of cavity 140 during subsequent anodic bonding, for example.

Referring now also to structure 410C, the silicon wafer 130 may be anodically bonded to another plate 230, thereby sealing the array of cells in the inert atmosphere, at around 300 C. The cells may then be diced or cleaved apart to provide individual cells 100, for example.

Where a cell (FIG. 1) having a small cavity inner dimension is desired, it may prove desirable to provide for a high environmental pressure within the cell cavity (e.g., a high intra-cavity pressure). For example, the desired intra-cavity cell pressure may approach several atmospheres, or even up to about 10 atmospheres, at cell operating temperature. Where the desired cavity 140′, 140″, 140′″, 140″″ pressure is high, the pressure of the pin transfer environment likewise needs to be high. Further, where the desired operating temperature of each cell is lower than the anodic bonding temperature, e.g., at or above about 300 C, the pressure needs be higher to compensate for the reduced operating temperature effect on the pressure.

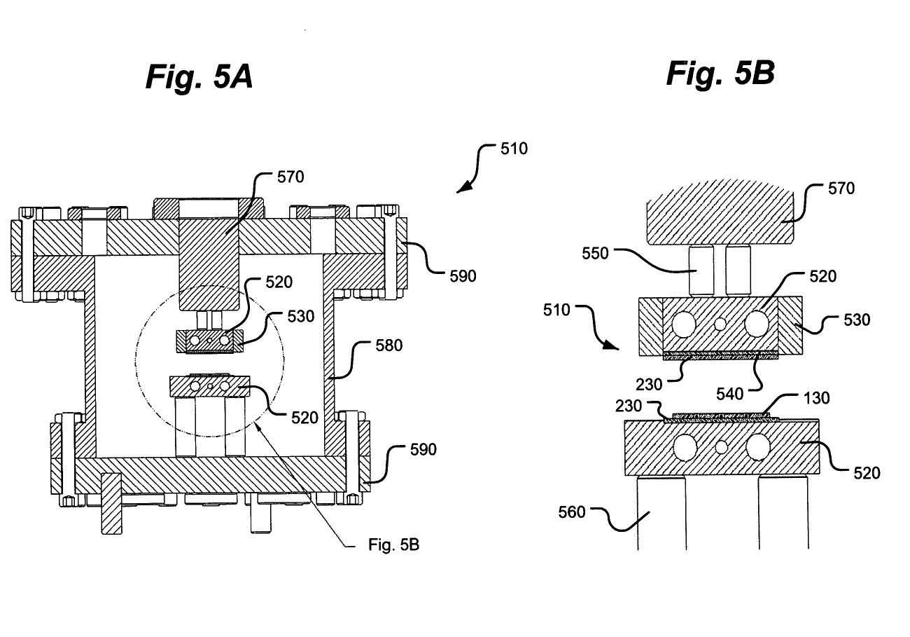

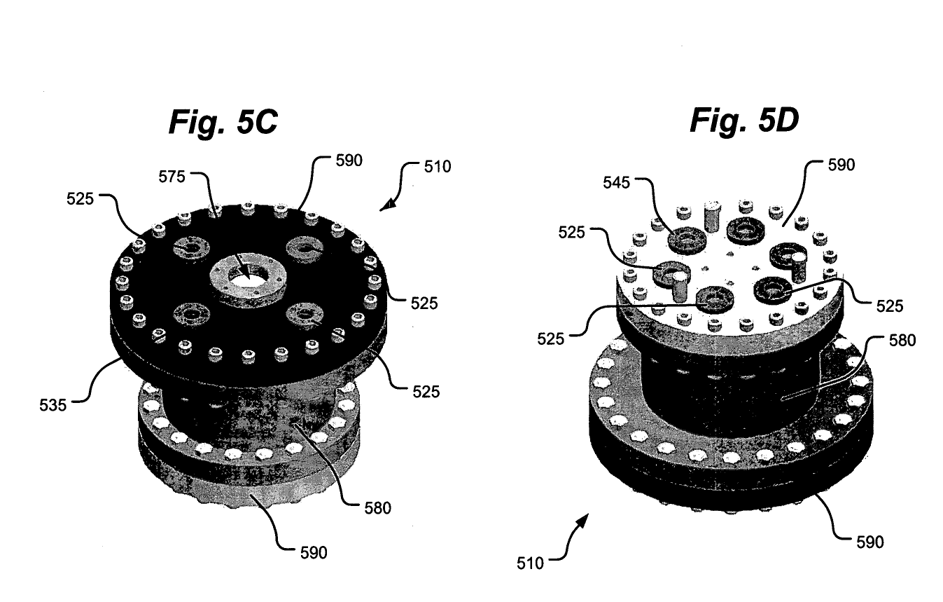

Referring now also to FIGS. 5A-5D, there are shown various views of an apparatus 510 suitable for use with the process of FIG. 4 at a high nitrogen/argon environmental pressure, e.g., in excess of about 1 atmosphere or 760 Torr.

Apparatus 510 generally takes the form of a vessel suitable for providing a high environmental pressure within a cell 100 cavity 140 (FIG. 1) prior to sealing. The entire vessel may be placed within a glove box to facilitate the steps demonstrated by the structures 410A and 410B of FIG. 4. While in the glove box, the vessel may be sealed, and have a high pressure nitrogen/argon environment introduced there into. The cell 100 cavity 140 (FIG. 1) may then be sealed within the high pressure environment, and the vessel de-pressurized.

Referring first to FIGS. 5A and 5B, apparatus 510 generally includes heating plates 520 for supporting, on one hand, a plate 230 and wafer 130, and on the other hand, another plate 230. Heaters 520 may take the form of resistive heaters. Each of the heaters 520 may include leads to facilitate resistively heating plates 230 and wafer 130 to a temperature suitable for anodic bonding. Alternatively, heaters 520 may take the form of blocks of thermally conductive material having channels for receiving heated fluids. In such a case, each of heaters 520 may include channels for receiving the heated fluid, for heating the plates 230 and wafer 130 to a temperature suitable for anodic bonding.

One or more of the heaters 520 may include an annular ring 530 for holding a plate 230 during processing. Ring 530 may secure a plate 230 by laterally pressing against it. One or more of heaters 520 may include a thermally conductive layer 540, such as graphite, for enhancing thermal conduction between a heater 520 and plate 230.

One of the heaters 520 may be secured to a plunger 570 by three legs 550 to facilitate a planar alignment of an attached plate 230 to a plate 230 and wafer 130 combination held by another heater 520. The other heater may be supported within the vessel using a plurality of legs 560, such as three or four, for example. Each of the legs may be made of a thermally insulating material, such as a ceramic, for example.

The apparatus 510 vessel itself may include a cylindrical body portion 580 having caps 590 secured by bolts at the ends thereof. With caps 590 secured to body 580, the apparatus vessel may be suitable for containing a high pressure environment, such as up to 10 atm or more. Such a vessel is sometimes referred to as a “bomb”.

In operation, once liquid cesium has been placed within the respective cavities (see, e.g., FIG. 4), the vessel may be sealed and pressurized with the desired buffer gas (e.g., a N and Ar mixture). The plunger may then be used to align the a plate 230 and wafer 130, on the other hand, with another plate 230. Anodic bonding of the wafer 130 to the second plate 230 may then be effected under high pressure. Thereafter, the vessel may be de-pressurized and cooled, and the resulting cell array removed from the vessel, and a vessel-containing glove box.

Referring now also to FIGS. 5C and 5D, there are shown perspective views of apparatus 510. Apparatus 510 may further include a plurality of pressure and electrical ports to enable the process discussed with regard to FIG. 4 to be carried out within apparatus 510. For example, apparatus 510 may include electrical ports 525 for facilitating anodic bonding, by applying an about 1 kV potential across a plate 230 and wafer 130, and activating heating plates 520. Apparatus 510 may include pressure relief port(s) 535 for releasing the pressure within the vessel after anodically bonding both plates 230 to wafer 130. Apparatus 510 may include port(s) 545 for pressurizing the vessel, e.g., injecting a nitrogen and argon mix into the vessel.

The present invention will be discussed as it relates to incorporating a cell analogous to that shown in FIG. 1, and discussed hereinabove. However, alternative cell structures, such as those illustrated in, and discussed with regard to, FIGS. 8A-13 of the afore-incorporated U.S. patent application Ser. No. 11/030,009, filed Jan. 30, 2005, entitled ANODICALLY BONDED CELL, METHOD FOR MAKING SAME, AND SYSTEMS INCORPORATING SAME (SAR-14968) may also be used.

By way of non-limiting example, cell 100 (FIG. 1) may be suitable for use with the method and system described in U.S. patent Publication No. 2004/0233003A1, entitled “METHOD AND SYSTEM FOR OPERATING AN ATOMIC CLOCK WITH REDUCED SPIN-EXCHANGE BROADENING OF ATOMIC CLOCK RESONANCES”. This patent publication discloses an end-transition scheme that may be leveraged according to an aspect of the present invention. The end-transition scheme is also discussed in U.S. patent Publication No. 2004/0202050A1, “METHOD AND SYSTEM FOR OPERATING AN ATOMIC CLOCK WITH SIMULTANEOUS LOCKING OF FIELD AND FREQUENCY”, “SPIN-EXCHANGE BROADENING OF ATOMIC CLOCK RESONANCES”, by D. K. Walter and W. Happer, Laser Physics, Vol. 12, No. 7, 2002, pp. 1-6, and “INTENSE, NARROW ATOMIC-CLOCK RESONANCES”, by Y.-Y. Jau et al., Physical Review Letters, Vol. 92, no. 11. The entire disclosures of these patent publications is hereby incorporated by reference herein.

However, it should be understood that one possessing an ordinary skill in the pertinent art would not have been motivated to use miniature cells (e.g., <1 mm in dimension), even with an end-transition approach, because it would be expected that the increased thermal requirements of the cell would make it much less efficient than a larger cell, and efficiency is considered to be more important than size. Accordingly, there is no motivation to make inefficient cells, no matter how small. However, the inventors hereof have invented small, efficient cells. That is, it has been discovered that an unexpected advantage of using an end-transition approach with miniature cells is that miniature cells (e.g., 100, FIG. 1) are actually more efficient than larger cells. It is believed this is a result of the thermal heating requirements of a system according to the present invention only growing logarithmically with decreasing cell size, while heat radiative losses in such a system drop quadratically with decreasing cell size.

Referring now also to FIG. 6, there is shown a non-limiting example of a system 600 incorporating structure 100 of FIG. 1. System 600 may be well suited for being placed in a chip-scale housing. System 600 generally includes layers 110, 120 and 130 positioned between a reflecting system 610 and an emitting/detecting system 620. Reflecting system 610 may include a reflector, such as a mirror or grating structure, suitable for use with signal(s) 620′ emitted from system 620 through structure 100. System 620 may include an emitter, such as a vertical cavity surface emitting laser (VCSEL), and detector (collectively, 620). The VCSEL may be suitable for emitting signal(s) 620′, while the detector is suitable for detecting signals 610′ reflected by system 610. Emitted signals may have a center wavelength around 894 nm, by way of non-limiting example only. In an embodiment, the VCSEL may have an operating threshold current of around 1 mA or less. In an embodiment, the VCSEL may have an operating threshold current of around 0.5 mA or less. In an embodiment, the VCSEL may be modulated at around 9.193 GHz, for example. Detector 620 may take the form of one or more amplitude detectors, such as one or more photodiodes, for example. System 600 may include additional elements, such as a neutral density filter 630 and/or ¼ waveplate 640 positioned between system 620 and structure 100. Alternatively, such a filter and/or waveplate may be incorporated into system 620 or structure 100, for example. System 600 may include a semiconductor based amplitude modulator 650 positioned between source 620 and cavity 140. Modulator 650 may serve to amplitude modulate emissions 620′ prior to their introduction to cavity 140 consistently with the CPT approach discussed below. Modulator 650 may be incorporated into system 620 or structure 100, for example.

According to an aspect of the present invention, the emitter and detector need not be co-located. For example, the detector may take the place of reflecting system 610.

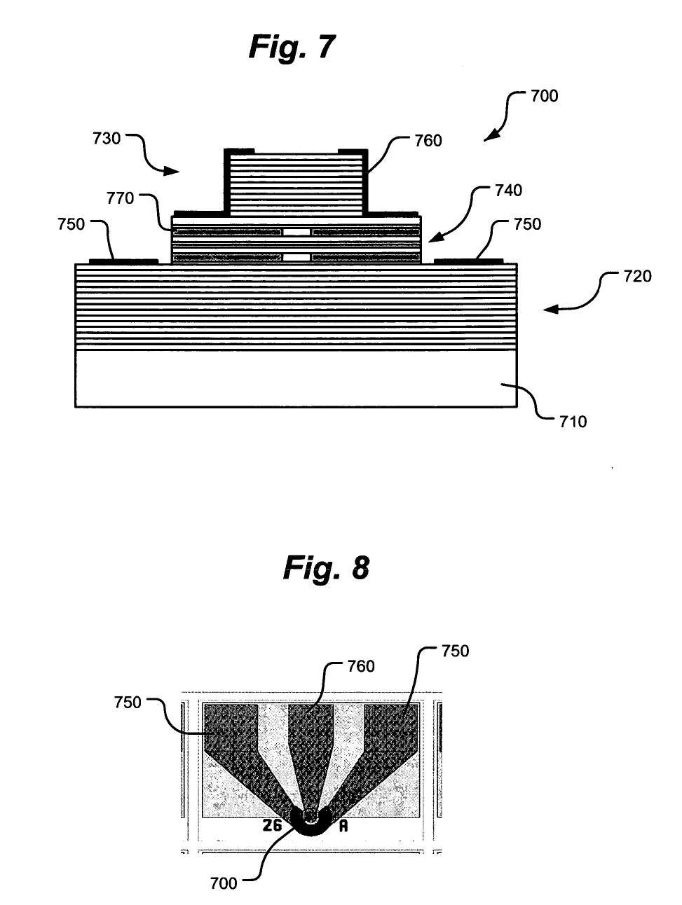

Referring now to FIG. 7, there is shown a VCSEL structure 700 suitable for use as the emitter of emitter/detector 620. VCSEL 700 generally includes a substrate 710, reflectors 720, 730 and active region 740. By way of non-limiting example, substrate 710 may take the form of a GaAs substrate. Reflector 720 may be formed over substrate 710, and take the form of a multilayer, AlGaAs based reflector. Active region 740 may be formed over reflector 720. Active region 740 may take the form of a conventional quantum well-based active region, such as an InGaAs/AlGaAs material based system. By way of further, non-limiting example, active region 740 may be single quantum well (SQW) based or multi-quantum well (MQW) based, and include upper and lower cladding layers compatible with the material system of the quantum well(s).

VCSEL 700 may further include aperture layers 770 on opposing lateral sides of active region 740. Aperture layers 770 may serve to better confine the optical energy in the lateral direction. Aperture layers 770 may include centralized optically transmissive regions, such as regions composed of AlGaAs, and peripheral oxide regions, such as regions composed of AlₓO_{y}. Reflector 730 may be formed over substrate active region 740, and take the form of a multilayer, AlGaAs based reflector.

Referring now to FIGS. 7 and 8, VCSEL 700 may further include n- and p-ohmic contacts 750, 760 for the active region 740, respectively. Contacts 750, 760 may provide for co-planar electrical connectivity for VCSEL 700, thereby enabling undoped multi-layer AlGaAs based reflectors 720, 730 to be used. As will be understood by those possessing an ordinary skill in the pertinent arts, this may provide for a more efficient device than if the reflector layers were doped to provide electrical conductivity for active region 740. The lateral dimensions of a VCSEL 700 suitable for use with the cell of FIG. 1, may be on the order of about 450 μm by about 320 μm.

VCSEL 700 may be provided with one or more conventional heater layers, which may be analogous to heaters 115 of cell 100 (FIG. 1). VCSEL heaters may be used to heat VCSEL 700 to operating temperature.

By way of further non-limiting example only, VCSEL 700 may have a structure analogous with that illustrated in Table-1.

TABLE 1

| # | Layer | Al content | Doping (cm⁻³) | Thickness (nm) | Comments |
|---|---|---|---|---|---|
| 1 | substrate | 0. | ˜ | ˜ | |
| 2 | intermediate | 0. | U | ˜ | |
| 3 | graded (31) | 0.06 −> 0.9 | U | 20 | |
| 4 | low index quarter wavelength (31) | 0.9 | U | 50.7 | |
| 5 | graded(31) | 0.90 −> 0.06 | U | 20 | |
| 6 | high index quarter wavelength (31) | 0.06 | U | 43.5 | |
| 7 | graded | 0.06 −> 0.9 | U | 20. | |
| 8 | low index near quarter wavelength | 0.9 | U | 50. | |
| 9 | N-contact layer | 0.06 | N-2*10\hat{ }18 | 93 | |
| 10 | Etch stop | InGaP | N-2*10\hat{ }18 | 33 | total thickness all layers |
| | | | | | between surface and N-etch stop - |
| | | | | | 3. 6 microns |
| 11 | Step layer | 0.06 | N-2*10\hat{ }18 | 20 | |
| 12 | graded layer | 0.06 −> 0.95 | N-2*10\hat{ }18 | 20 | |
| 13 | oxidation layer | 0.95 | N-2*10\hat{ }18 | 73 | |
| 14 | half quarter | 0.90 | N-1*10\hat{ }18 | 36.1 | |
| 15 | graded waveguide | 0.6 −> 0.3 | U | 96 | |
| 16 | outer barrier | 0.3 | U | 20 | |
| 17 | QW (3) | In˜0.1 ?? | U | 6 | |
| 18 | internal barrier (2) | 0.3 | U | 8 | |
| 19 | outer barrier | 0.3 | U | 20 | |
| 20 | graded waveguide | 0.3 −> 0.6 | U | 96 | |
| 21 | half quarter | 0.90 | P-1*10\hat{ }18 | 36.1 | |
| 22 | oxidation layer | 0.95 | P-2*10\hat{ }18 | 73. | |
| 23 | graded layer | 0.95 −> 0.06 | P-2*10\hat{ }18 | 20 | |
| 24 | P-contact layer | 0.06 | P-3*10\hat{ }18 | 229. | |
| 25 | InGaP | InGaP˜˜˜˜˜ | U | 33.3 | etch stop |
| 26 | low index near quarter wavelength | 0.9 | U | 59.3 | total thickness all layers |
| | | | | | between surface and etch stop - |
| | | | | | 2.8 microns |
| 27 | graded layer(20) | 0.90 −> 0.06 | U | 20 | |
| 28 | high index quarter wavelength (20) | 0.06 | U | 43.5 | |
| 29 | graded layer(20) | 0.06 −> 0.90 | U | 20 | |
| 30 | low index quarter wavelength (20) | 0.9 | U | 50.7 | |
| 31 | graded layer (ending) | 0.90 −> 0.06 | U | 20 | |
| 32 | high index quarter wavelength ending | 0.06 | U | 43.5 | |

Suggested PL wavelength for the QW ˜0.875 nm

Table-1 illustrates the structure from the substrate to the top contact. First, the bottom mirror from 31.5 pairs of undoped quasi quarter wavelength layers Ga_{0.94}Al_{0.06}As/Ga_{0.10}Al_{0.90}As may be grown, with intermediate graded layers between them. Each layer together with the graded layer gives accurately quarter wavelength optical thickness on the wavelength in question. On the top of the mirror, and N-contact layer from Ga_{0.94}Al_{0.06}As n-type doped (N˜2*10¹⁸ cm⁻³) may be grown (layer 9). After this, follows an etch stop layer from InGaP that provides for bottom contact preparation (layer 10). Layers 11 and 12 are added before the first oxidation layer 13 to provide the same environment for the both oxidation layers (second oxidation layer is layer 22). It is known that the oxidation rate depends not only from composition and thickness of the oxidation layer but on composition of the layers that are in contact with it. So, one may provide the same layers around both oxidation layers. Layers from 14-21 form the waveguide structure with three InGaAs quantum wells in the middle for effective injection and leakage prevention. Layers 14 and 21 serve both: 1) for accurate alignment between antinode of the optical mode and quantum well position, and 2) for separation of the optical waveguide from the oxidation layer. Layer 22 is the second oxidation layer, layer 23 is the graded layer and layer 24 is the P-contact layer. Due to low conductivity of p-type GaAlAs, a thickness of p-contact layer may be chosen around 229 nm, corresponding approximately to one wavelength in the material and doped it till 3*10¹⁸ cm⁻³ to provide low spreading resistance. Layers 21-23 are also p-type doped to serve as injector layers. On the top of the p-contact layer is the InGaP etch stop layer (layer 25). Its purpose is to facilitate formation of the top contact. The layers 26-32 form the 20.5 pairs top mirror. This mirror is also undoped to provide for low optical losses.

For non-limiting purposes of further explanation only, the mirror composition was determined from the following considerations. First it is preferably to have maximal possible contrast between the refractive indexes of the two quarter wave length layers of the mirror to decrease the number of layers for the same reflection. The constraint on the high refractive index layer is the interband absorption on the lasing wavelength. So Ga_{0.94}Al_{0.06}As was chosen as the material for the high reflective layer. The oxidation procedure sets limitations on the composition of the low refractive index layers. These layers in the top mirrors are exposed to oxidation agents together with the oxidation layers with an appropriate difference in the oxidation rate to preserve the functionality of the top mirror. From this consideration the Ga_{0.10}Al_{0.90}As was chosen.

Grading may be introduced between the mirror layers to preserve the mechanical integrity of the mirror and mitigate the risk of cracking that may otherwise occur after the oxidation.

While these limitations may not apply to the bottom mirror, it may prove advantageous to have both mirrors of the same structure to simplify growth. Understanding however, that grading the bottom mirror may require an additional 3-4 pairs and additional penalty in 2-3 pairs for choosing Ga_{0.10}Al_{0.90}As instead AlAs.

Further, it may prove desirable to provide for a VCSEL 700 well adapted for high-speed operation, particularly in combination with the RF interrogation approach described herein. In such as case, it may be desirable to provide for low series resistance in the VCSEL, as the resistance adds directly to the VCSEL RC time constant. A large component of the series resistance is from the ohmic contacts between the semiconductor and the metal pad. Constraints in device design often prevent using larger contact areas as a method of achieving low contact resistance though. It is therefore necessary to have semiconductor-metal interfaces that have low contact resistivity, which is the contact resistance normalized to the contact area.

In GaAs-AlGaAs material system, well known methods exist for making low contact resistivity p-type ohmic contacts to p-GaAs. If there is an AlGaAs layer, the usual practice is to include a p-GaAs top layer in the device for the purpose of making a low resistivity ohmic contact. However, in some devices, such as a short wavelength vertical cavity surface-emitting laser, the p-GaAs layer will add unacceptably large optical losses, such that it is desirable for low resistivity ohmic contacts to be made directly on the p-AlGaAs instead. This may prove difficult because the aluminum at the surface forms an aluminum oxide film that prevents the metal and underlying semiconductor from coming into intimate contact.

Low resistivity ohmic contacts directly to n-AlGaAs have been made depositing Pd/AuGe/Ag/Au metallization and annealing to a temperature of approximately 350 C. The mechanism of ohmic contact formation was unclear, but was speculated to be similar to one proposed for PdGe ohmic contacts on GaAs. Therein, the Pd reacts with GaAs near room temperature to form an intermetallic compound PdₓGa_{y}As with x˜4 and y˜1. The native oxide of GaAs, which is expected to be on the surface of the GaAs before the deposition of the metals and is unavoidable without using high vacuum techniques, is not visible by transmission electron microscopy. Presumably, the Pd dispersed the oxide as it formed the PdₓGa_{y}As. More reactions occur during the annealing. Some of the Ge reacts with Pd not bound to PdₓGa_{y}As to form the compound PdGe. Also, excess Ge is transported through the PdGe and PdₓGa_{y}As layers into the underlying GaAs during the anneal. The Ge that reaches the GaAs will either occupy Ga vacancies in the GaAs created during the PdₓGa_{y}As formation to dope the GaAs heavily n-type or it will form an epitaxial Ge layer. Both will assist in the creation of a low contact resistivity ohmic contact.

Pd-based ohmic contacts depend on Ge to play a critical role. Because Ge is a donor in GaAs, Pd cannot be used with Ge for p-type contacts. However, according to an aspect of the present invention low contact resistivity p-type ohmic contacts may be achieved using Pd/AuZn/Au. We speculate that some, but not all, of the reactions that occur in the PdGe contacts to n-GaAs occur here, and these are sufficient to create a low contact resistivity ohmic contact to p-AlGaAs. Specifically, and by way of non-limiting further explanation only, we speculate that the Pd disperses the native oxide, which consists of oxides of Al as well as those of Ga and As, as it forms PdₓGa_{y}As. Ga vacancies, which will be filled by Zn to dope the surface of the AlGaAs heavily p-type during the anneal, are also created during the PdₓGa_{y}As formation. These two reactions may prove critical in the formation of low contact resistivity ohmic contacts to p-AlGaAs.

The following demonstrates that Pd/AuZn/Au forms low contact resistivity ohmic contacts to AlGaAs. A wafer consisting of p-Al_{0.06}Ga_{0.94}As may eb provided. The wafer was divided and a different metallization was deposited on each piece: (a) 50 nm Ti/20 nm Pt/200 nm Au which is a standard p-contact metallization used for lasers, (b) 15 nm Au/105 nm AuZn/200 nm Au and (c) 5 nm Pd/100 nm AuZn/150 nm Au. Metallization (a) was deposited by electron beam evaporation and the other two metallizations were deposited by thermal evaporation. AuZn was deposited from a source that was 5% Zn by weight at the beginning of the deposition. No further effort was made to control the Au to Zn ratio during the deposition. The metals are listed in the order in which they were deposited. The metals were patterned by lift-off so that the transmission line method (TLM) can be used to evaluate the contact resistivity. Each sample was divided into several pieces that were annealed for different time durations and at different temperatures. Metallization (b) did not adhere to wafer, indicating a lack of any reaction near room temperature between the AlGaAs and the first layer of Au. Results for the other two metallizations are given in Table 2.

TABLE 2

| | Anneal | | |
|---|---|---|---|
| | Temperature | Anneal Time | Contact Resistivity |
| Metallization | (° C.) | (sec) | (Ω-cm²) |
| (a) Ti/Pt/Au | None | None | 1 × 10⁻³ |
| (a) Ti/Pt/Au | 445 | 10 | 3 × 10⁻⁴ |
| (a) Ti/Pt/Au | 470 | 10 | 3 × 10⁻⁴ |
| (b) Au/AuZn/Au | None | None | Did not adhere |
| (c) Pd/AuZn/Au | None | None | 1.7 × 10⁻⁴ |
| (c) Pd/AuZn/Au | 445 | 10 | 4.7 × 10⁻⁵ |
| (c) Pd/AuZn/Au | 445 | 40 | 2.0 × 10⁻⁵ |
| (c) Pd/AuZn/Au | 470 | 10 | 2.7 × 10⁻⁵ |
| (c) Pd/AuZn/Au | 470 | 40 | 2.8 × 10⁻⁵ |

Thus, according to an aspect of the present invention, a Pd/AuZn/Au contact, even without anneal, may be used as an efficient contact, and even exhibit better performance than the standard Ti/Pt/Au. That it has low resistivity without anneal and that it adhered (whereas the Au/AuZn/Au did not) together suggests that there is a reaction, possibly the formation of PdₓGa_{y}As and the dispersal of the native oxide, that occurs near room temperature.

It is anticipated that the Pd/AuZn/Au metallization will give lower contact resistivity than 2.0×10⁻⁵ Ω-cm² with further metallization, anneal time and anneal temperature optimization. And, that such an approach is well suited for use with VCSEL 700, particularly in combination with the RF interrogation approach described herein.

Further, like cells 100 (FIG. 1), VCSELs 700 may be suitable for batch processing, such that multiple VCSELs 700 may be formed on a common substrate and then cleaved or diced into separate devices.

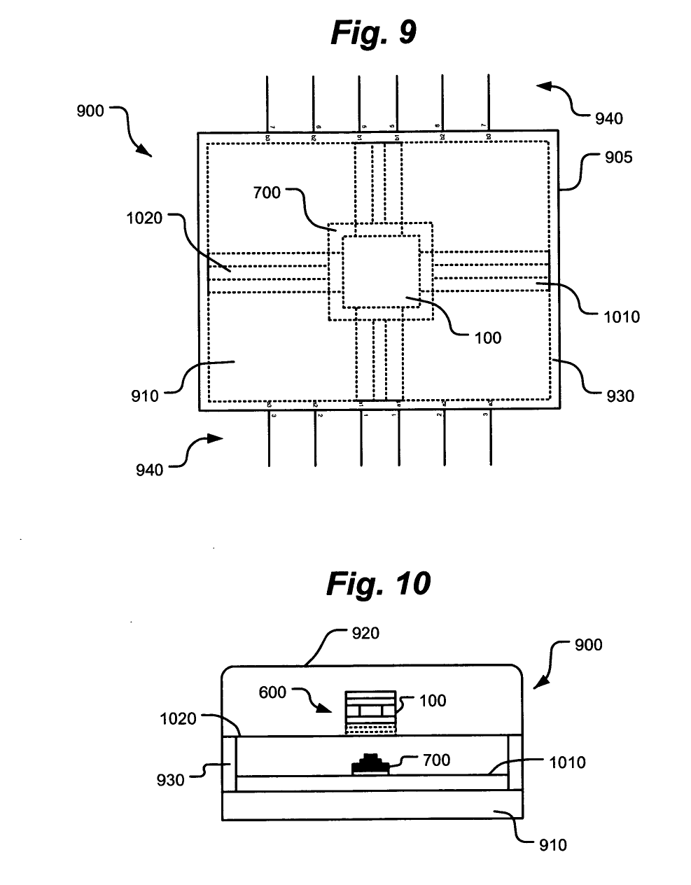

According to an aspect of the present invention, VCSEL 700 (FIG. 7) and cell 100 (FIG. 1) may be positioned within a common package, such that emissions from VCSEL 700 impinge upon the atomic vapor within cavity 140 of cell 100. Referring now also to FIGS. 9 and 10, there are shown plan and cross-sectional views of a packaged device 900 according to an aspect of the present invention. Packaged device 900 may include a ceramic housing 905 including a substrate portion 910 and cap portion 920 and defining an interior hollow. The housing may be portable and chip-scale in size. By way of non-limiting example only, the housing may be on the order of about 30 mm×30 mm×10 mm, or smaller. The hollow may have a low pressure environment contained therein, such as a pressure below atmospheric pressure, or a vacuum. Having a vacuum within the housing 905 cavity may facilitate thermal management of components housed therein. As is discussed herein below, thermally isolating elements within housing 905 may prove particularly advantageous according to an aspect of the present invention.

Referring still to FIGS. 9 and 10, the illustrated packaged device 900 includes an emitter, such as VCSEL 700 (FIG. 7), and metal atomic vapor containing cell, such as cell 100 (FIG. 1). A reflector (e.g., 610, FIG. 6) may be secured to the cell opposite from the VCSEL. In such a case, a photodiode may be incorporated with VCSEL 700 to provide for an emitter/detector combined device (e.g., 620, FIG. 6). Alternatively, a photodiode may be secured to the cell opposite from the VCSEL. Other components may be included, such as those illustrated in system 600 (FIG. 6), as well as electronics. RF and magnetic shielding may be interposed between the electronics and cell, for example. The present invention will be further described with respect to elements 100, 600, 700 for non-limiting purposes of explanation only.

VCSEL 700 and cell 100 may be substantially thermally isolated from one another within packaged device 900. This may be accomplished by essentially suspending these elements within the vacuum housing 905. By way of further, non-limiting example, VCSEL 700 and cell 100 may be suspended in an optically interconnected manner upon polyimide (e.g., Kapton from Dupont) based suspensions 1010, 1020. Optionally, a photodiode may be suspended in an analogous manner to receive VCSEL emissions through cell 100.

Referring still to FIG. 10, according to an aspect of the present invention, each suspension 1010, 1020 may include a plurality of arms stretching from one or more support(s) (or frame(s)) 930 and forming cross-like shapes. Other shapes, such as ones incorporating more or less support arms may also be used though. Further, while the arms are shown in the illustrated case to be substantially symmetrical for a given suspension 1010, 1020, one or more of the arms may be thinner or thicker, or shorter or longer than the others.

Regardless, support(s) 930 may be formed of silicon or glass, for example. Electrical connectivity for VCSEL 700 and cell 100 may be provided by conductive wire lines extending along one or more of the polyimide based arms and being electrically connected to these elements and corresponding package contact pins 940. The wire lines may take the form of gold strip lines, for example.

The arms of suspension 1010 may be of suitable dimensions to generally mitigate thermal leakage from VCSEL 700, yet avoid thermal runaway at maximum operating temperature by providing some heat-sinking functionality. The arms of suspension 1020 may be of suitable dimensions to mitigate thermal leakage from cell 100. For example, the arms of suspension 1010 may generally be wider than the arms of suspension 1020.

To form suspensions 1010, 1020, a polyimide film may be secured, such as adhesively fixed, to a frame that provides support(s) 930. The polyimide film may be patterned, such as by being machined. VCSEL 700 and cell 100 may be adhesively affixed to the patterned polyimide suspension and attached frame combinations. Multiple (such as two) suspensions and supports may be physically affixed together to provide a composite, stacked suspension structure analogous to that shown in FIGS. 9 and 10. Laser drilling may be used to provide optical communicability between VCSEL 700 and cell 100 through the polyimide layer.

Alternatively, a polyimide layer, such as a layer about 5 μm to about 25 μm thick may be spin-coated onto the silicon wafer or glass member. The polyimide layer may be patterned to provide for arms extending from a periphery to a substantially centralized portion thereof. Portions of the substrate under the polyimide layer may be selectively removed to provide the suspension. For example, a silicon wafer or glass member may be provided. Laser drilling and/or other conventional selective removal techniques may be used to pattern the polyimide layer into a suspension shape (e.g., suspension 1010, 1020, FIG. 10) and remove portions of the silicon wafer or glass member to form support(s) 930. Multiple (such as two) suspensions and supports may be physically affixed together to provide a composite, stacked suspension structure analogous to that shown in FIGS. 9 and 10.

Alternatively, deposition, spin-coating and selective removal techniques may be iterated to form stacked suspensions, such as those designated 1010, 1020 in FIG. 10.

Either way, electrical connectivity may be provided by patterning Au strip lines across the polyimide suspension arms between pins 940 and VCSEL 700 or cell 100, respectively. Thereafter the housing 905 cavity may be evacuated and sealed by cap portion 920. A conventional getter and electronics for operating device 900 may also be provided within the housing, for example. The housing may take the form of a ceramic chip, for example. And, RF and/or magnetic shielding may be interposed between the electronics on one hand and VCSEL, cell and/or photodetector on the other hand.

VCSEL 700 (FIG. 7) emissions traversing the cavity 140 within packaged device 900 may either directly, or by being reflected by reflector 610 (FIG. 6), impinge upon a photodetector, e.g., emitter/detector 620 (FIG. 6). The photodetector may be well suited for detecting the intensity of the VCSEL 700 (FIG. 7) emissions that have passed through the cavity 140 (FIG. 1). A commercially available photodiode, such as UDP Sensors Inc; Part PIN-125DPL, may be used.

The transmissivity of the atomic vapor within cavity 140 results in VCSEL 700 emissions passing there through to impinge the photodetector with a corresponding intensity. The detected changes in the light intensity impinging the photodetector may be used to lock a clock to the hyperfine transition frequency of the alkali-metal atoms in the cavity 140. By way of non-limiting example, in implementation, cell pressure may be in the order of about 300 Torr or higher, the cell optical path length may be on the order of about 1 mm or less, and the operating temperature may be on the order of about 110° C.

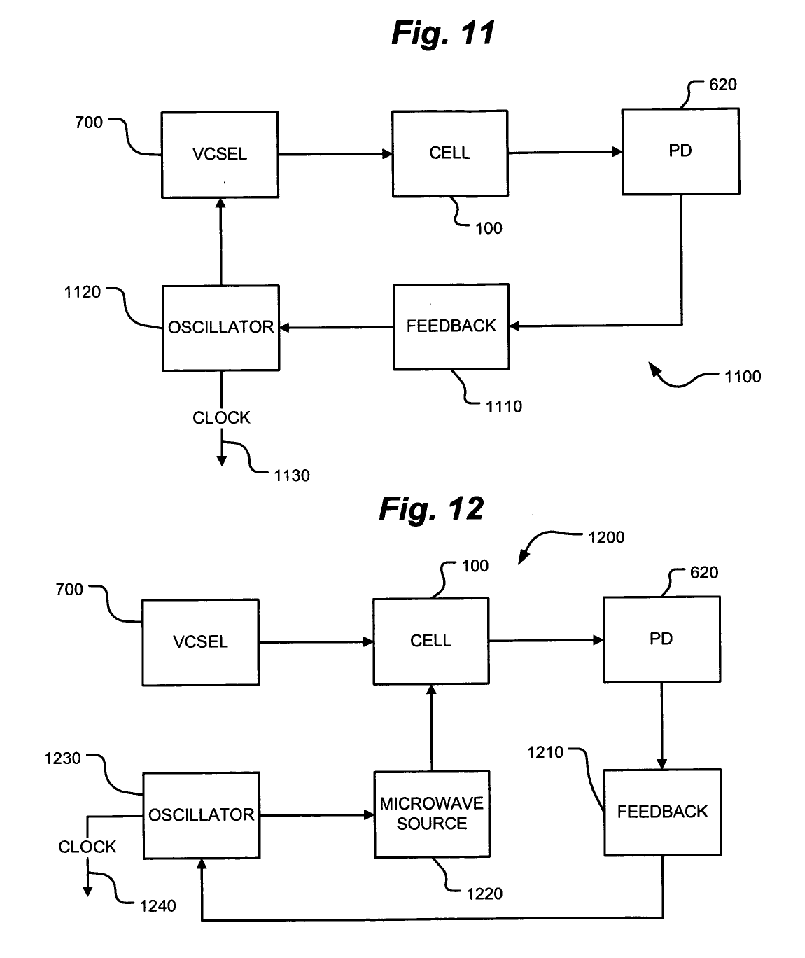

According to an aspect of the present invention, in operation a coherent population trapping (CPT) approach may be used with packaged device 900. CPT may be used in combination with an end transition scheme by aligning a magnetic field impinging the cell 100 cavity at an angle of 45° to VCSEL 700 emissions (as opposed to along the VCSEL 700 emissions for a 0-0 scheme). This may be accomplished using any magnetic field inducing device, such as permanent magnets, for example. Referring now also to FIG. 11, there is shown a block-diagrammatic representation of system 1100 utilizing such an approach. In such a case, VCSEL 700 may be directly modulated responsively to an oscillator 1120 to produce two coherent optical tones separated by a given frequency. Where the optical tone separation matches the hyperfine transition frequency of the alkali-metal atoms in cavity 140 of cell 100, e.g., 9.193 GHz for Cs, less optical energy is absorbed by the alkali-metal atoms, and a corresponding peak DC power intensity may be detected using a photodetector (e.g., 620 of FIG. 6). Conventional feedback mechanisms 1110 may be used to tune the oscillator 1120 being used to directly modulate VCSEL 700, to provide optical tones with the hyperfine transition frequency separation. The fine-tuned oscillator 1120 may also be tapped to provide a signal 1130 from which the desired frequency clock signal may then be conventionally deduced.

Alternatively, and also according to an aspect of the present invention, an RF interrogated approach may be used with packaged device 900. Such an approach may be particularly well suited for use with cells having outer dimensions of around 200 μm, or less, for example. RF interrogation may be used in combination with an end transition scheme by configuring RF field oscillations that impinge the cell to be perpendicular to the VCSEL 700 field oscillations (as opposed to parallel with the VCSEL 700 emissions for a 0-0 scheme). This may be accomplished by positioning a microwave signal source accordingly, for example. Referring now also to FIG. 12, there is shown a block-diagrammatic representation of system 1200 utilizing such an approach. In such a case, VCSEL 700 may provide a continuous wave (CW) optical signal to cell 100. Additionally, a microwave signal source 1220 may be used to excite the cell 100. Microwave signal source 1220 may be modulated responsively to an oscillator 1230. According to an aspect of the present invention, different one(s) of the arms 1020 (FIG. 10) may be used to provide heater electrical connectivity and strip lines for providing the microwave signals. The striplines providing the microwave signals may either terminate at the cell 100 peripheries, or pass there over, for example. Either way, the cell 100 itself may be directly irradiated by the radio frequency (RF) field corresponding to the microwave signals responsively to the oscillator 1230, to again produce two coherent optical tones separated by a given frequency. Where the optical tone separation matches the hyperfine transition frequency of the alkali-metal atoms in cavity 140 of cell 100, e.g., 9.193 GHz for Cs, less optical energy is absorbed by the alkali-metal atoms, and a corresponding peak DC power intensity may be detected using a photodetector (e.g., 620 of FIG. 6). Conventional feedback mechanisms 1210 may be used to tune the oscillator 1230. The fine-tuned oscillator 1230 may again be tapped to provide a signal 1240 from which the desired frequency clock signal may then be conventionally deduced.

According to an aspect of the present invention, where system design constraints dictate minimizing the cell size and maximizing the intra-cavity pressure used, the RF interrogation approach may prove particularly well suited. Where an end-transition scheme is used, further clock stabilizing through magnetic field stabilization may be used. According to an aspect of the present invention, feedback stabilization of the magnetic field by direct, phase sensitive detection of the Zeeman resonance in the atomic vapor may be used.

Where the 0-0 resonance scheme is used, operation is not dependent on the magnetic field to the first order. However, as set forth herein, it may prove desirable to use an end-resonance or transition approach. One drawback of this approach though lies in that the end-resonance frequency depends on the magnetic field. To first order, the end-resonance frequency is given by: fₑ=f₀₋₀+3f_{z}, where f₀₋₀ is the resonance frequency of the 0-0 transition and f_{z} is the Zeeman frequency. The Zeeman frequency depends on the magnetic field. In the case of Cs it dependence may be characterized as

$${f}_{z} = 350.3 \frac{kHz}{G} \cdot B$$

where B is the DC magnetic field. According to an aspect of the present invention, the magnetic field may be stabilized to mitigate potentially deleterious effects of this dependence. According to an aspect of the present invention, a method for stabilizing the magnetic field by direct phase sensitive detection of the Zeeman resonance may be used.

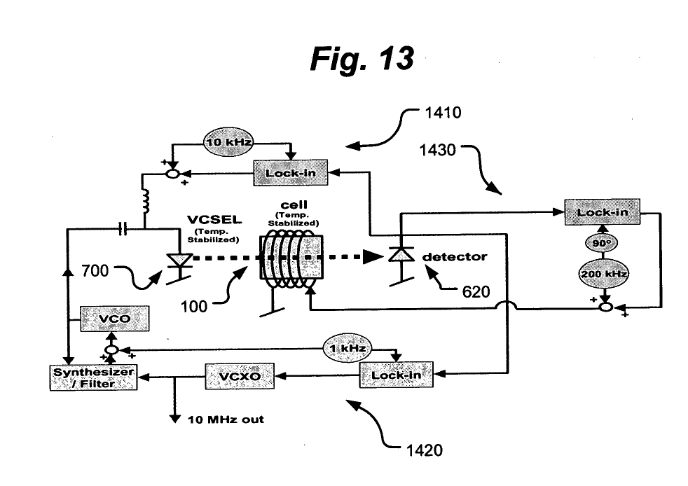

A schematic of an atomic clock with the proposed magnetic field stabilization is shown in FIG. 13. The clock includes three feedback loops. One loop 1410 is used to lock the VCSEL 700 wavelength to the absorption peak of cell 100—using the dependence of the VCSEL 700 wavelength on the injection current, for example. A second loop 1420 is used to lock a local oscillator to the microwave end-resonance. The output of this loop is the clock output.

The common principle of these two feedback systems 1410, 1420 is that wavelength or frequency is dithered around the resonance at a low frequency (in the schematic: at 10 kHz for the wavelength loop and at 1 kHz for the microwave frequency loop). The signal at that frequency in the detector is then demodulated with a lock-in circuit, sometimes referred to as a turbo-loop. The demodulated signal is fed back to readjust the wavelength/frequency with a proportional-integral (PI) feedback circuit.

Referring still to FIG. 13, control loop 1410 may be seen to include a lock-in circuit coupled to a 10 KHz source and detector 620. The output of the lock-in circuit is summed with the 10 KHz signal and inductively coupled to VCSEL 700. Control loop 1420 may be seen to include a lock-in circuit having inputs coupled to detector 620 and a 1 KHz source signal. The lock-in circuit feeds a voltage controlled, temperature compensated crystal oscillator, in-turn having an output coupled to a synthesizer and filter. The temperature compensated crystal oscillator (TCXO) may take the form of an Epson, part TG-5000, for example. The synthesizer may take the form of a National Semiconductor, part LMX-2434, for example. The 1 KHz signal is summed with the output of the synthesizer/filter and provided as an input to a voltage controlled oscillator, having an output coupled to the synthesizer/filter and capacitively coupled to VCSEL 700. The voltage controlled oscillator may take the form of a Sirenza Microdevices, part VCO690-4790T, for example. The servo loop may optionally omit the TCXO and synthesizer, if operated in in digital IC with “lock-in” detection performed in software, such as is offered by NIST in conjunction with Ceyx Technologies.

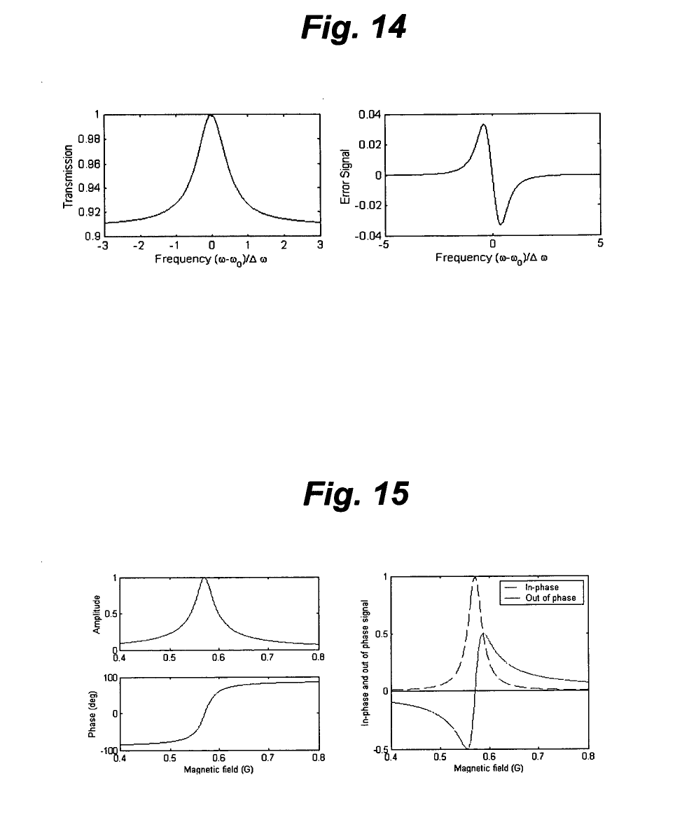

A calculated transmission signal as a function of the frequency of the hyperfine microwave resonance signal and the corresponding error signal is shown in FIG. 14. The dithering and lock-in detection may be used to create the error or correction signal. The feedback may be used to drive the local oscillator to lock into the zero crossing of the error signal at the resonance peak.

The frequency at which the microwave frequency is dithered around the resonance should be smaller than the resonance width. The resonance does not respond to higher FM dither frequencies. The Allan variance σ(τ) of the frequency of the clock will follow the relation, with appropriate feedback, and for long times:

$${σ}^{2} ( τ ) = \frac{1}{2 {f}_{e}^{2} τ} \frac{{S}_{Nf}}{{\vert \frac{ⅆ {e}_{f}}{ⅆ f} \vert}^{2}} + {σ}_{e}^{2} ( τ ) ,$$

where S_{Nf} is the noise spectral density in the error signal, fₑ is the clock frequency,

$$\frac{ⅆ {e}_{f}}{ⅆ f}$$

is the slope of the error signal versus local oscillator frequency and σₑ(τ). is the Allan variance of the atomic microwave resonance frequency.

Referring again to FIG. 13, the principle of the third loop, the magnetic field feedback loop 1430, is different than the loops 1410, 1420. According to an aspect of the present invention, the current in a coil around the atomic vapor cell may be modulated at a constant frequency (200 kHz in the non-limiting schematic in FIG. 1). The resulting magnetic field modulation induces a modulation of the laser beam provided that the atomic vapor Zeeman resonance frequency is at or close to the applied frequency. The modulation, which is picked up by the laser light as it passes through the cell, is detected and the lock-in provides phase sensitive demodulation at that frequency.

The modulated light intensity can be written as (in complex form to describe amplitude and phase):

$${P}_{z} = \frac{{P}_{z0}}{1 - j 2 \sqrt{3} \frac{B \frac{ⅆ {f}_{z}}{ⅆ B} - {f}_{z0}}{Δ {f}_{z}}} ,$$

where B is the DC magnetic field, f_{z0} the frequency at which the magnetic field is modulated and Δf_{z} is the resonance width of the Zeeman signal. P_{z0} is depends of the input power, magnetic field modulation amplitude and cell parameters,

$$\frac{ⅆ {f}_{z}}{ⅆ B}$$

is the rate at which the Zeeman frequency shifts with magnetic field.

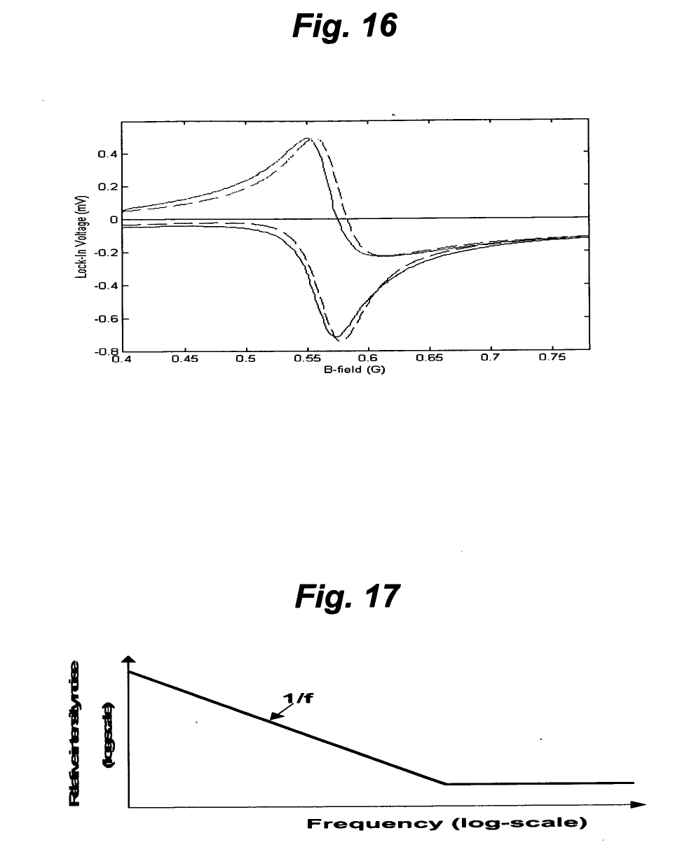

Calculated amplitude and phase of modulation picked up by the light as a result of magnetic field modulation in the cell is shown in FIG. 15. As may be seen, the modulation is predicted to be strongest as the Zeeman resonance frequency and applied modulation frequencies coincide. In addition, the phase of the modulation changes across the resonance. Decomposition of this signal into components in-phase and out-of-phase with the applied modulation are shown in FIG. 16. The out-of-phase component crosses zero at the resonance. Phase sensitive demodulation allows detecting this component. It can be used in a feedback circuit to drive the magnetic field to the point where this signal crosses zero, and hence the Zeeman resonance coincides with the applied modulation frequency. Expected in-phase and out-of-phase components are shown in FIG. 16, for non-limiting purposes of further explanation only.

As may be recognized by those possessing an ordinary skill in the pertinent arts, this scheme is different than a scheme based on sensing the transmission of the light through the cell. Here, the modulation picked up by the light is measured. This modulation can be processed directly by phase sensitive detection of the out-of-phase component.

Noise resulting from laser noise, shot-noise of the detector or thermal noise may contaminate the signal. However, only a small portion of the noise spectrum around the demodulation frequency will appear at the output of the phase sensitive detection. This noise may nonetheless limit how well the magnetic field can be stabilized though.

Residual fluctuations of the magnetic field may deteriorate clock stability since the atomic microwave resonance will fluctuate with the magnetic field. A clock with a magnetic field locked by feedback the Allan variance σ(τ). of the clock frequency will follow the relation:

$${σ}^{2} ( τ ) = \frac{1}{2 {f}_{e}^{2} τ} ( \frac{{S}_{Nf}}{{\vert \frac{ⅆ {e}_{f}}{ⅆ f} \vert}^{2}} + 3 \frac{{S}_{NB}}{{\vert \frac{ⅆ {e}_{B}}{ⅆ {f}_{z}} \vert}^{2}} ) ,$$

where S_{NB} is the noise in the error signal of the magnetic field loop and

$$\frac{ⅆ {e}_{B}}{ⅆ {f}_{z}}$$

is the slope of the magnetic field loop error signal versus magnetic field modulation frequency. The additional second term in the equation may thus be minimized in order not to deteriorate overall clock performance.

Referring again to FIG. 13, the magnetic feedback-loop 1430 includes a lock-in circuit having an input coupled to detector 620. The lock-in circuit has another input that receives a 90° phase-shifted 200 KHz signal. The output of the lock-in circuit is summed with the 200 KHz signal, and the result is used to excite electrical winding(s) around cell 100 cavity 140—thereby inducing a magnetic field within the cavity 140.

A schematic of a typical laser noise spectrum is shown in FIG. 17. At low frequencies (below MHz range), the spectrum typically follows a 1/frequency dependence. The choice of the demodulation frequency thus has a considerable impact on the noise in the correction signal. According to an aspect of the present invention, the demodulation frequency in the magnetic field feedback loop 1430 can be chosen by applying a substantially constant magnetic field. For example, with a 1 Gauss magnetic field, the Zeeman resonance of Cs is at 350.3 kHz. With larger magnetic fields the frequency can be extended into the MHz range. This scheme allows work at a frequency considerably larger than the resonance width of the Zeeman resonance (which is in the few kHz range). With a dither scheme that detects the transmission of the laser light through the cell the dither-and demodulation frequency is limited to the resonance width.

Taking design criteria into consideration, in general, a larger cell size may be used to provide an increased figure-of-merit (FOM) (contrast (ppm)/linewidth (Hz)). However, this may be undesirable due to design constraints. A higher cell pressure may also be used to provide an increased FOM. Increased FOM may also be realized from a N₂ cell environment, although incorporating Ar may be used to address long term drift instabilities. The use of an end-transition approach also provides a larger FOM than the 0-0 transition at higher intensities (e.g., around 10 mW/cm² or higher). In fact, the end transition method may be used to provide dramatically improved FOM for small, high-pressure cells as compared to conventional methods (assuming the alkali atoms are pumped into the end state with a nearly 100% efficiency, which may be achieved using the described optically pumped, RF interrogated approach).

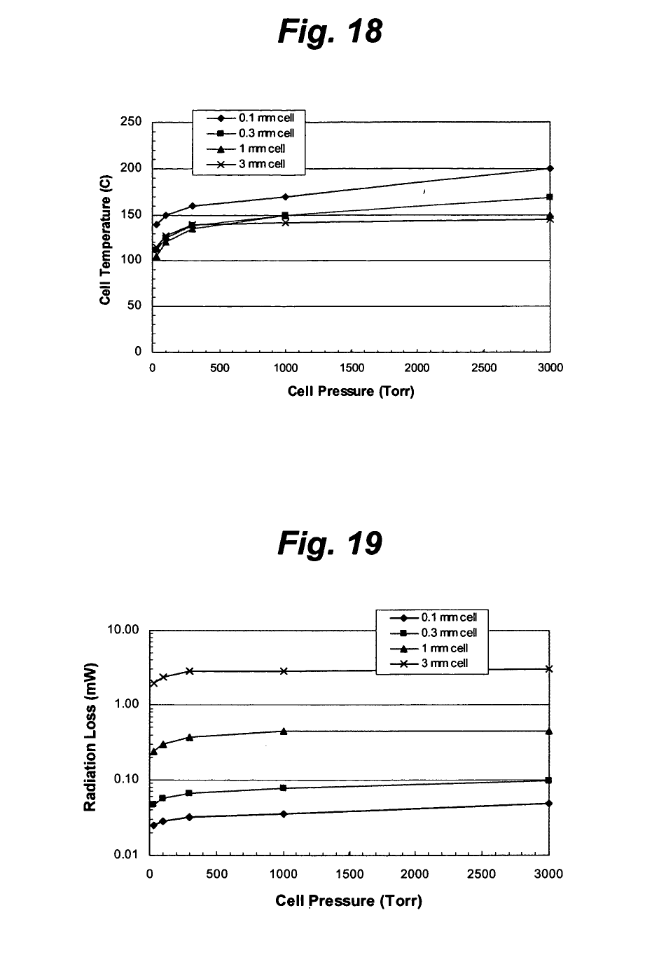

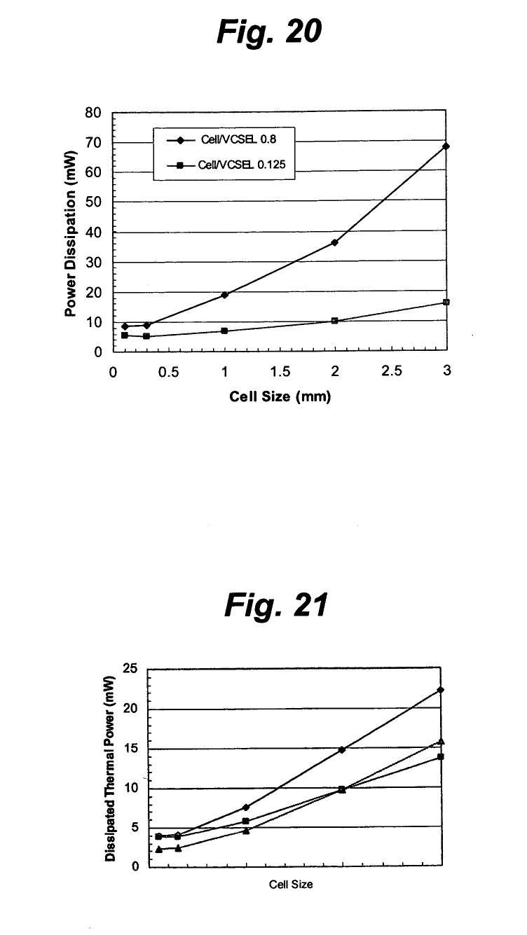

Referring now to FIGS. 18-20, there are shown some design consideration simulation data according to an aspect of the present invention. Referring first to FIG. 18, as may be seen therein, smaller cell size and higher cell intra-cavity pressure may dictate high cell operating temperatures—requiring heating. However, as may be seen in FIG. 19, higher cell pressure (and smaller cell size) though requiring higher operating temperature also yield lower radiation losses (due to less radiating area, for example). Consistently, and as may be seen in FIG. 20, power dissipation is predicted to increase with increasing cell size. In FIG. 20, the upper curve reflects a thermal conductivity figure between the VCSEL and cell of around 0.8, where the lower curve reflects a thermal conductivity figure between the VCSEL and cell of around 0.125.

Thus, a frequency standard (e.g., clock signal) may be provided by disciplining a crystal oscillator to the hyperfine transition of an alkali vapor in batch-fabricated, batch-filled and batch-sealed cells. The transition frequency is about 9.193 GHz for cesium, and about 6.83 GHz in rubidium. Generally, an optical source pumps the atoms of the atomic vapor in the cell from a ground state to an excited state. In addition, an RF source is also provided to the atoms to provide atomic spin coherence. The RF signal may be provided from a microwave cavity, or imparted directly through laser modulation sideband generation. The transmissivity of the cell depends on the RF frequency and results in light passing there through to impinge a photodetector with a corresponding intensity. In typical atomic clock systems, the amount of light that reaches a photodetector through a resonance cell will change by about 0.1% when the alkali vapor in the resonance cell is exposed to microwave power at or near the transition frequency. Detected changes in the light intensity impinging the photodetector may be used in a feedback loop to lock an oscillator to the hyperfine transition frequency of the alkali-metal atoms of the atomic vapor.

Further, where it is considered desirable to build an accurate clock of small size, weight, and power while maintaining high timing accuracy, an end-transition, optically pumped, RF-interrogated clock according to an aspect of the present invention may typically take several design criteria that depend on cell size into account. For example, dependence upon cell size of heater power required to maintain the cell at sufficient temperature to create a given number of alkali atoms per unit volume (volume density) in the vapor may be considered. The dependence upon cell size of required volume density may be considered. The dependence upon cell size of the contrast of the hyperfine resonance signal may be considered. The dependence upon cell size of the linewidth of the hyperfine resonance signal may be considered. According to an aspect of the present, the design may take these design criteria into account as follows.

A sharp dependence of heater power on cell surface area is responsible for dramatically lower power requirements for the chip-scale atomic clock system as cell size is reduced. A logarithmic, i.e., small, dependence of heater power on the required volume density in the cell is provided for by the exponential dependence of alkali vapor number density on temperature. The increase of number density is required as cell size is reduced. This small dependence is, however, more than compensated by the dramatic decrease in surface area of a smaller cell.

With decreased cell size, the ratio of hyperfine signal contrast to linewidth (the so-called atomic clock figure-of-merit (FOM)) is, in general, reduced (i.e., impaired) owing to de-phasing spin-exchange collisions among alkali metal atoms comprising the vapor. Ceteris parabus, this decrease of FOM leads to significantly reduced performance for small clocks. However, as taught by the incorporated patents and referenced publications, the practice of pumping to the end state to achieve nearly 100% spin polarization of the alkali vapor can effectively eliminate the de-phasing effect of such collisions. Under such conditions, decreased cell size does not significantly impair clock performance.

Conventional atomic clocks, including published so-termed chip-scale atomic clocks, employ alkali vapor cells of minimum 2 mm dimension. In contradistinction to conventional prior art designs, and taking the above design criteria into account, a chip-scale atomic clock of <1 mm cell size may be achieved. Such a clock may be, in effect, specified by the following components.

First, an alkali metal vapor cell of <1 mm outside dimension with provision for heating, temperature control, maintenance of a clear and specular optical path through the cell, a reservoir of alkali metal, an ambient of buffer gas of pressure and composition chosen to maximize figure of merit and long-term drift performance, and means for thermal isolation of the cell from ambient utilizing such methods as vacuum packaging and heat shielding. Second, a light source capable of emitting highly polarized light, such as linearly polarized light, at a wavelength corresponding to a D1 or D2 energy level transition of an alkali vapor atom, for example 894 nm or 852 nm respectively for cesium, with low threshold current <1 mA with provision for independent temperature control over the light source to tune its wavelength within the absorption band of the D1 or D2 energy level transition photon energy. Third, passive optical components as necessary to transform linearly to circular polarized light. Fourth, a photodetector and amplifier to measure the transmitted light intensity and deliver it to control circuitry. Fifth, an electromagnet to control the ambient magnetic field to provide sufficient radio frequency separation between adjacent transitions of the Zeeman transition manifold associated with the hyperfine split ground state of the alkali atoms. Sixth, a commercially available wavelength-controllable source of RF energy combined with an RF waveguide to conduct hyperfine frequency energy to the cell tuned to the end-transition frequency. Seventh, an integrated small-size (<30 cm³) low-power servo control, input/output, and power supply circuitry to regulate laser temperature, cell temperature, ambient magnetic field, and RF frequency. Eighth, small mechanical, electrical, and thermal fixtures necessary to physically support the aforementioned components in an overall package of size <100 cm³ or the equivalent volume distributed over a collection of modules in a larger system.

Further, the design of such a system leads to several design conclusions. First, the alkali vapor cell and laser emitter must operate at temperatures greater than the maximum ambient temperature, eliminating any need for large power consuming cooling elements. Second, in the case of maximum ambient temperature, the laser heater may be turned off; and the laser maintains its operating temperature due to self-heating derived from non-radiative processes. For a given laser efficiency, thermal isolation supports (e.g., supports 930, FIG. 9) may be used to maintain the laser at a constant operating temperature. For a low power atomic clock, a low power, efficient laser is particularly well suited. Hence, a VCSEL laser with sub 500 μA threshold current may be selected. The more efficient the VCSEL (output laser power/input electrical power), the smaller the residual thermal buildup, and the more thermally isolating the support can be utilized. Thermally resistive supports provide the benefit of low thermal drive power when ambient temperature decreases; i.e., VCSEL temperature is maintained at maximum ambient from self-heating, while integrated heating element(s) may be used at lower ambient temperatures. The more efficient the VCSEL, the more thermally isolating the support can be, and the less power the VCSEL heater will consume to maintain operating temperature as ambient is reduced.

In the case of maximum ambient temperature, and assuming the VCSEL is thermally decoupled from the cell, integrated heating element(s) may be used to maintain the cell operating temperature.

The amount of power needed to drive the heating element is dependent on the thermal loss of the cell and supports. As cell size is reduced, its needed operating temperature is increased to maintain needed optical absorption path length. Thus, it is conventionally thought power needs will likewise increase with reduced cell size. However, even with increasing needed operating temperature, reduction in cell size leads to reduction in heater power as the decrease in cell surface area reduces radiated power faster than increases in temperature T (radiated power loss ∝ emissivity*surface_area*T⁴).

Low emissivity surface coatings may be used to further reduce radiated power. Convective loss may be eliminated by packaging the system into a vacuum enclosure (e.g., 905, FIG. 9). Thermally resistive supports (e.g., 930, FIG. 9) may be used to minimize conductive thermal power loss to ambient. As ambient temperature is reduced, cell heater power may be increased to maintain the cell operating temperature.

The end-transition approach may thus be well suited for use with small, high pressure, high temperature cells to provide good signal strengths. In an embodiment, RF-interrogated end-transition, inner cell dimensions below 1 mm allow for strong signals with an intra-cavity buffer gas pressure greater than 0.5 atmospheres (high buffer gas pressures are desirable for reduced clock instability due to light shifts). For FM modulated CPT end-transition based systems, 1 mm cell sizes or below may be achievable, but buffer gas pressure less than 0.5 atm may be needed due to unresolved optical lines with increased pressure. This effect may result in FM modulated CPT being susceptible to clock instabilities due to large light shifts. For an AM modulated CPT approach, 1 mm cell sizes or below may be achievable, with buffer gas pressures greater than 0.5 atm. However the signal strength of this approach is less than that of RF-interrogation, and AM modulation would require external modulation of light in an AM sensitive modulator. Such a modulator may possibly be integrated onto the emitting VCSEL aperture, for example though.

Referring now also to FIG. 21, there is shown the thermal power dissipation of a VCSEL, cell physics package as a function of cell innermost dimension. Triangles describe a cell with wall thickness equal to 25% of inner cell dimension, the cell being fabricated with vertical sidewalls from deep Reactive Ion beam Etching (DRIE). The squares describe power dissipation when utilizing DRIE with fixed cell wall thickness of 500 μm. The diamonds describe power dissipation with cell fabricated from wet-chemical etching along silicon crystal plane. As can be seen, reduced cell dimension leads to reduced system power dissipation—despite the need for increased heating. Utilization of fixed wall thickness and wet-etching limit the outer cell dimension, and hence limit power reduction. Scaled wall thickness, in this case outer cell dimension 1.25% of inner dimension, leads to continual reduction in power dissipation (˜2 mW, excluding VCSEL dissipation assumed to be 2.5 mW in this example). Saturation of thermal power dissipation with cell dimension below 100 μm is also due to increase in needed cell temperature.

It will be apparent to those skilled in the art that various modifications and variations may be made in the apparatus and process of the present invention without departing from the spirit or scope of the invention. Thus, it is intended that the present invention cover the modification and variations of this invention provided they come within the scope of the appended claims and their equivalents.

What is claimed is:

1. A clock comprising:
a portable, at least partially evacuated housing;
a cell being positioned within said housing and including an internal cavity having interior dimensions each less than about 1 millimeter, an intra-cavity pressure of at least about 760 Torr, and containing a metal atomic vapor;
an electrical to optical energy converter being positioned to emit light through said metal atomic vapor;
an optical energy intensity detector being positioned to receive said light emitted by said converter through said metal atomic vapor;
at least one conductive winding around said cavity for stabilizing the magnetic field experienced in said cavity dependently upon said detector; and,
an output for providing a signal dependently upon said detector detecting said light emitted by said converter through said metal atomic vapor.

2. The clock of claim 1, further comprising:
a radio frequency signal source being positioned with respect to said cell such that the radio frequency signal field oscillations are substantially perpendicular to the field oscillations of said light emitted by said converter; and,
an oscillator being electrically coupled to said radio frequency source to modulate said radio frequency signal source dependently upon said detector.

3. The clock of claim 2, wherein said radio frequency signal source comprises at least one strip line being substantially adjacent to said cell.

4. The clock of claim 1, further comprising a reflector being supported within said housing to reflect at least a portion of said light emitted by said converter through said metal atomic vapor to said detector.

5. The clock of claim 1, further comprising at least one magnetic field inducing device positioned to induce a magnetic field that impinges the cell at an angle of about 450 relative to said light emitted by said converter.

6. The clock of claim 1, wherein said intra-cavity pressure is at least about 1520 Torr.

7. The clock of claim 1, wherein said intra-cavity pressure is at least about 2280 Torr.

8. The clock of claim 1, wherein said metal atomic vapor comprises a cesium atomic vapor.

9. The clock of claim 9, wherein said cavity further contains an approximately 72.5% Nitrogen and 27.5% Argon gas mixture at a pressure greater than about 760 Torr.

10. The clock of claim 1, wherein said cell comprises a silicon wafer and a plurality of plates comprising an amorphous silicate having an ion mobility and temperature expansion coefficient approximately that of silicon, which wafer and plates collectively define said cavity.

11. The clock of claim 1, further comprising at least one heater being thermally coupled to said cell to heat said metal atomic vapor to an operating temperature.

12. The clock of claim 1, further comprising at least one optical element being supported within said housing and optically interposed between said converter and cell, said at least one optical element being selected from the group consisting of: a neutral density filter, ¼ waveplate and optical amplitude modulator.

13. The clock of claim 1, wherein said electrical to optical energy converter comprises a vertical cavity surface emitting laser (VCSEL).

14. The clock of claim 13, wherein said VCSEL comprises co-planar p- and n-electrical contacts.

15. The clock of claim 14, wherein said VCSEL comprises at least one aperture layer including a substantially centralized substantially optically transmissive region and a peripheral substantially optically non-transmissive region.

16. The clock of claim 14, wherein said VCSEL comprises a quantum well based active region positioned between multilayer reflectors.

17. The clock of claim 17, wherein said multilayer reflectors are substantially un-doped.

18. The clock of claim 14, further comprising a heater being thermally coupled to said VCSEL to heat said VCSEL to an operating temperature.

19. The clock of claim 14 wherein said VCSEL has a threshold current around 1.0 mA or less.

20. The clock of claim 20, wherein said VCSEL has a threshold current around 0.5 mA or less.

21. The clock of claim 1, further comprising at least two suspensions spanning said housing and each supporting one of said electrical to optical energy converter and cell.

22. The clock of claim 21, wherein said suspension are thermally insulating.

23. The clock of claim 22, wherein said suspensions each comprise a plurality of polyimide based arms.

24. The clock of claim 23, wherein at least one of said arms supporting said electrical to optical energy converter is more thermally conductive than at least one of said arms supporting said cell.

25. The clock of claim 23, wherein at least one of said arms supporting said electrical to optical energy converter is larger than at least one of said arms supporting said cell.

26. The clock of claim 1, wherein said housing is a ceramic chip.

27. The clock of claim 1, wherein said housing is around 30 mm×30 mm×10 mm or smaller.

28. The clock of claim 1, wherein said cell has outer dimensions each less than about 200 μm.
